(19) United States
(12) Patent Application Publication
(10) Pub. No.: US 2011/0057893 A1
(43) Pub. Date: Mar. 10, 2011

(54) Touch screen panel

(76) Inventors: Do-Youb Kim, Yongin-city (KR); Won-Kyu Kwak, Yongin-city (KR); Brent Jang, Yongin-city (KR); Ja-Seung Ku, Yongin-city (KR); Soon-Sung Ahn, Yongin-city (KR)

(21) Appl. No.: 12/801,336

(22) Filed: Jun. 3, 2010

(30) Foreign Application Priority Data
Sep. 4, 2009 (KR) 10-2009-0083409

(51) Int. Cl. G06F 3/041

(52) U.S. Cl. 345/173

(57) ABSTRACT

A touch screen panel comprises a glass substrate having a display area and a non-display area, a plurality of sense patterns on the display area, a plurality of metal pads on a periphery of the display area and on the non-display area, a plurality of sense lines on the non-display area, and dummy patterns on an area between the plurality of sense lines on the non-display area. The non-display area is outside a periphery of the display area. Each of the plurality of the sense lines is coupled to one of the plurality of metal pads. The display area and non-display area of the glass substrate respectively correspond to a display area and non-display area of an image display device to which the touch screen panel is provided.

### BACKGROUND

1. Field

The embodiments relate to a touch screen panel, and more particularly, to a touch screen panel that is provided in an image display device, etc.

2. Description of the Related Art

A touch screen panel is an input device into which a user can input his or her instruction by selecting instruction contents displayed on the screen of an image display device, etc. using a human hand or an object.

To this end, the touch screen panel provided on the front face of the image display device converts a location of an area directly contacted by the human hand or the object into electrical signals. Therefore, the selected instruction content on the contacted area is received as an input signal.

A separate input device that is coupled to the image display device to be operated, such as a keyboard and a mouse, may be replaced with such a touch screen panel, and the usage range of the touch screen panel has been gradually expanded.

There are a resistive type, a light sensitive type, a capacitive type, etc. of touch screen panel.

In a capacitive type of touch screen panel, conductive sense patterns may be formed. When a part of the conductive sense patterns is touched by a human hand or an object, neighboring conductive sense patterns act as a ground electrode. That is, a capacitive type of touch screen panel senses a change in capacitance, and converts a contact location into electrical signals. To this end, a plurality of sense patterns may be formed on a display area of the capacitive type of touch screen panel. On the other hand, pad parts that are coupled to respective sense patterns and sense lines that couple the pad parts to pads of a Flexible Printed Circuit (FPC) are formed on a non-display area. The non-display area may be formed in dead space, that is, in the area adjacent the periphery of the display area.

However, while the non-display area as dead space has been reduced recently, the number of sense patterns has been increased to improve sense ability. Consequently, a plurality of sense lines are formed on the non-display area, that is, in an area adjacent to the display area. Such an arrangement may cause a disadvantage in that the sense lines are easily revealed to a user's eyes.

For example, colored sense lines may be arranged on a transparent substrate. However, such sense lines cannot be arranged on the non-display area adjacent to the display area because the non-display area is reduced. Therefore, although a touch screen panel is attached to an image display device, the arrangement feature of the sense lines may be revealed to the user's eyes. This may cause visual annoyance when the user uses the touch screen panel.

### SUMMARY

Embodiments are therefore directed to a touch screen panel, which substantially overcome one or more of the problems due to the limitations and disadvantages of the related art.

It is therefore a feature of an embodiment to provide a touch screen panel, comprising: a glass substrate having a display area and a non-display area, the non-display area being outside a periphery of the display area, the display area corresponding to a display area of an image display device to which the touch screen panel is provided, and the non-display area corresponding to a non-display area of the image display device; a plurality of sense patterns on the display area of the glass substrate; a plurality of metal pads on a periphery of the display area of the glass substrate and on the non-display area of the glass substrate; a plurality of sense lines on the non-display area of the glass substrate, each of the plurality of the sense lines being coupled to one of the plurality of metal pads; and dummy patterns on areas between the plurality of sense lines on the non-display area of the glass substrate.

The dummy patterns may be made of the same material as the sense lines.

Each of the dummy patterns may be of an island shape, and may not be electrically coupled to the sense lines.

The sense patterns may include an X sense pattern and a Y sense pattern arranged on different layers.

The X pattern may include a plurality of first units, each of the first units may include a plurality of first sense patterns arranged in a first direction. The Y pattern may include a plurality of second units. Each of the second units may include a plurality of second sense patterns arranged in a second direction different from the first direction. Adjacent first sense patterns in each of the first units may be electrically coupled to each other in the first direction. Adjacent second sense patterns in each of the second units may be electrically coupled to each other in the second direction.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 is a schematic plan view illustrating a display area and a non-display area of an image display device on which a touch screen panel according to an embodiment is provided;

FIG. 2 is a schematic plan view illustrating the touch screen panel according to the embodiment; and

FIGS. 3A to 3C are cross-sectional views of exemplary systems in which the touch screen panel illustrated in FIG. 2 is provided.

### DETAILED DESCRIPTION

Korean Patent Application No. 10-2009-0083409, filed on Sep. 4, 2009, in the Korean Intellectual Property Office, and entitled: “Touch Screen Panel,” is incorporated by reference herein in its entirety.

Example embodiments will now be described more fully hereinafter with reference to the accompanying drawings; however, they may be embodied in different forms and should not be construed as limited to the embodiments set forth herein. In the drawing figures, the dimensions of layers and regions may be exaggerated for clarity of illustration.

In addition, when an element is referred to as being “on” other element, it can be directly on the other element or be indirectly on the other element with one or more intervening elements interposed therebetween. Also, when an element is referred to as being “connected to” or “coupled to” other element, it can be directly connected to or coupled to the other element or be indirectly connected to or coupled to the other element with one or more intervening elements interposed therebetween. Hereinafter, like reference numerals refer to like elements.

Hereinafter, exemplary embodiments will be described in more detail with reference to the accompanying drawings.

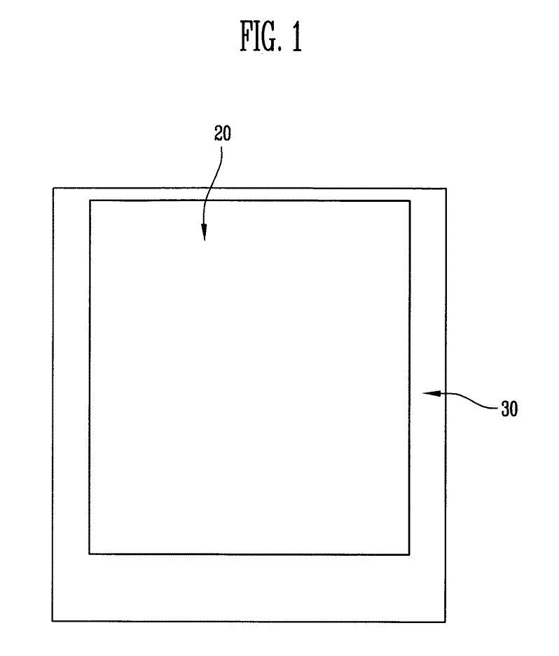

FIG. 1 is a schematic plan view of a display area and a non-display area of an image display device on which a touch screen panel according to an embodiment is provided.

Referring to FIG. 1, an image display device has a display area and a non-display area. The non-display area 30 may be provided in an area adjacent to a periphery of the display area 20.

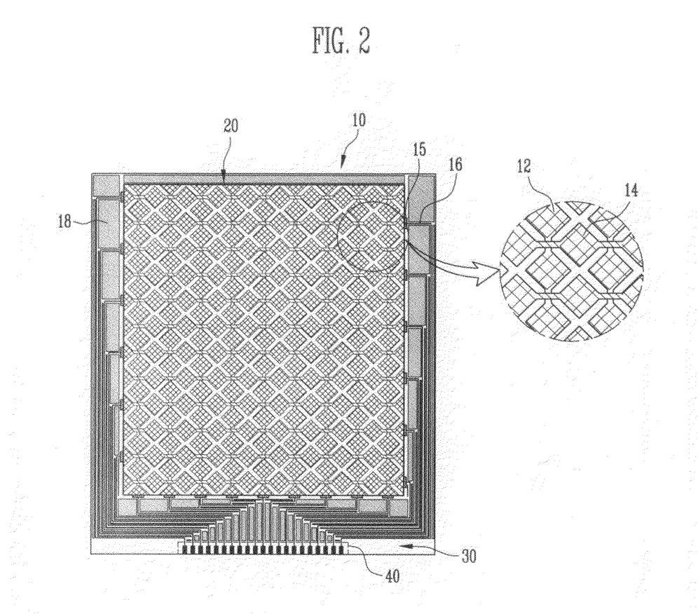

FIG. 2 is a schematic plan view of the touch screen panel illustrated in FIG. 1.

Referring to FIG. 2, the touch screen panel according to the embodiment may include a X sense pattern 12 and a Y sense pattern 14 formed on a transparent substrate 10, metal pads 15 and sense lines 16 electrically coupled to the X and Y sense patterns 12 and 14.

At this time, the X and Y sense patterns 12 and 14 may be formed on a display area 20 for displaying an image to detect a contact location. The metal pads 15 electrically coupled to the X and Y sense patterns 12 and 14 and the sense lines 16 may be formed on a non-display area 30.

The non-display area 30 should not be revealed to a user when the user uses the touch screen panel. However, the non-display area 30 may include a viewed area revealed to the user. The viewed area may be adjacent to the periphery of the display area 20.

Due to a recent trend of expanding the display area 20, while the non-display area 30 has been relatively reduced, more sense patterns 12 and 14 have been formed on the display area 20 to improve sensing ability. Consequently, the number of the metal pads 15 and the sense lines 16 formed on the non-display area 30 have also been increased.

Therefore, more sense lines 16 may be arranged in the viewed area, and an arrangement feature of the sense lines 16 may be undesirably revealed to the user's eyes and create a visual annoyance.

In the embodiment, in order to prevent the above-described visual annoyance, dummy patterns 18 may be formed on the area between the plurality of sense lines 16 arranged on the non-display area 30. The dummy patterns 18 may prevent the sense lines 16 arranged on the non-display area from being revealed to the user's eyes. The dummy patterns may be made of the same material as the sense lines 16.

However, in this case, each dummy pattern 18 may be formed to be an island shape between the respective sense lines 16 in order to prevent each dummy pattern 18 from forming a short circuit between the sense lines 16.

The dummy patterns 18 may be formed on the non-display area 30, or at least on the above-described viewed area. The sense lines 16 may be viewed as a black matrix instead of a specific arrangement feature of the sense lines even though the sense lines 16 are revealed to the user's eyes. Accordingly, visual annoyance may be prevented.

As shown in FIG. 2, the X sense pattern 12 and the Y sense pattern 14 may be formed on the display area 20. The X sense pattern 12 may include a plurality of column units, each of which includes a plurality of first sense patterns arranged in a first direction (column direction). The Y sense pattern 14 may include a plurality of row units, each of which includes a plurality of second sense patterns arranged in a second direction (row direction). Adjacent first sense patterns in each column unit may be coupled to each other. Adjacent second sense patterns in each row unit may be coupled to each other. The first sense patterns and the second sense patterns may be arranged alternately.

The X and Y sense patterns 12 and 14 as described above may be formed on different layers while a separate dielectric layer (not shown) is interposed therebetween.

In this case, the adjacent first sense patterns of the X sense pattern 12 may be patterned to be coupled to each other in the first direction in a patterning step. The adjacent second sense patterns of the Y sense pattern 14 may also be patterned to be coupled to each other in the second direction in a patterning step. Therefore, the process of forming a separate contact hole and coupling patterns may be omitted. Accordingly, the number of masks may be reduced, and the process may be simplified.

However, this is merely one of many embodiments. The embodiments are not limited to this one embodiment.

For example, the X sense pattern 12 and the Y sense pattern 14 may be formed on the same layer, or the glass substrate 10. In this case, the first sense patterns of the X sense pattern 12 or the second sense patterns of the Y sense pattern 14 may be formed in the first or second direction in the patterning step. The other sense patterns may be coupled to each other in the step of forming the contact hole and the coupling pattern.

Moreover, the metal pads 15 may be arranged on the peripheral area of the display area 20 on which the X and Y sense patterns 12 and 14 are formed, or on the peripheral area of the non-display area 30. The metal pad 15 may couple the X and Y sense patterns 12 and 14 to the plurality of sense lines 16 formed on the non-display area 30.

More specifically, the metal pads 15 may electrically couple the first sense patterns in each column unit of the X sense pattern 12 or the second sense patterns in each row unit of the Y sense pattern 14 to the respective sense lines 16, and may allow contact sensing signals to be transmitted to a driving circuit, etc.

For example, the metal pads 15 may electrically couple the second sense pattern in each row unit of the Y sense pattern 14 to the respective sense lines 16, while electrically coupling the first sense pattern in each column unit of the X sense pattern to the respective sense lines 16. The sense lines 16 may be electrically coupled to the X and Y sense patterns 12 and 14 through the metal pads 15, thereby electrically coupling them to the driving circuit (not shown).

In other words, when the touch screen panel 10 is coupled to an external driving circuit and a FPC through a pad part 40, the sense lines 16 may be coupled between the pad part 40 and the X and Y sense patterns 12 and 14.

If the touch screen panel is of a capacitive type and is contacted with a human hand or an object such as a touch stick, a change in capacitance corresponding to the contact location may be transferred from the X and Y sense patterns 12 and 14 to the driving circuit via the metal pads 15 and the sense lines 16. The change in capacitance may be converted into electrical signals by an X and Y input processing circuit (not shown), etc., and the contact location may be identified.

Furthermore, the dummy patterns 18 may be formed on the area between the plurality of sense lines 16 arranged on the non-display area 30. The dummy patterns 18 may be made of the same material as the sense line 16. Each of the dummy patterns 18 may be formed as an island shaped area between the respective sense lines 16, and is not electrically coupled to the sense lines in order to prevent the dummy patterns 18 from forming a short circuit between the sense lines 16.

In the embodiment, the dummy patterns 18 may be formed on the non-display area 30, or at least on the viewed area, which is a part of the non-display area 30 adjacent to the periphery portion of the display area 20. Thereby, even though the non-display area 30 is revealed to the user's eyes, the sense lines 16 may be shown as a black metal matrix instead of the arrangement feature of the sense lines 16. Accordingly, visual annoyance to the user may be prevented.

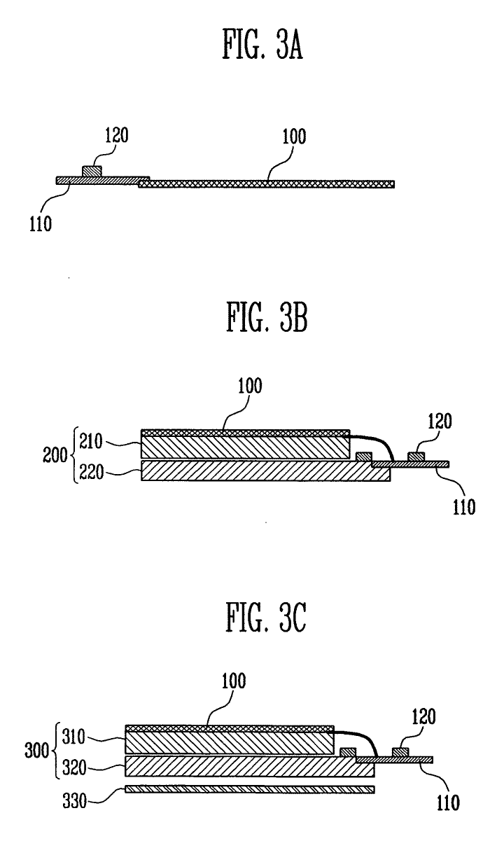

FIGS. 3A to 3C are cross-sectional views of exemplary systems in which a touch screen panel as illustrated in FIGS. 1-2 is provided.

First, as shown in FIG. 3A, the touch screen panel 100 may be formed on a separate substrate, and a pad part (not shown) formed on the substrate is coupled to a FPC on which a driving IC 120 is mounted. In this case, the touch screen panel 100 may be attached to the external surface of a separate image display device.

Alternatively, as shown in FIG. 3B, the touch screen panel 100 may be formed directly on a sealing substrate 210 of an organic light emitting diode display device 200 instead of the separate substrate. The pad part (not shown) formed on one end of the sealing substrate 210 may be coupled to the FPC 110 on which the driving IC 120 is mounted. The FPC 110 may be attached to a lower substrate 220 of the organic light emitting diode display device 200. An organic light emitting diode display device integrated slim touch screen may be implemented therethrough.

Alternatively, as shown in FIG. 3C, the touch screen panel 100 may be formed directly on a color filter substrate 310 of a liquid crystal display 300 with a backlight 330 provided on its lower portion rather than the separate substrate. In this case, the pad part (not shown) on one end of the color filter substrate 310 may be coupled to the FPC 110 on which the driving IC 120 is mounted, and the FPC 110 may be attached to a TFT substrate 320 of the liquid crystal display device. The liquid crystal display device integrated slim touch screen can be implemented therethrough.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A touch screen panel, comprising:
a glass substrate having a display area and a non-display area, the non-display area being outside a periphery of the display area, the display area corresponding to a display area of an image display device to which the touch screen panel is provided, and the non-display area corresponding to a non-display area of the image display device;
a plurality of sense patterns on the display area of the glass substrate;
a plurality of metal pads on a periphery of the display area of the glass substrate and on the non-display area of the glass substrate;
a plurality of sense lines on the non-display area of the glass substrate, each of the plurality of the sense lines being coupled to one of the plurality of metal pads; and
dummy patterns on areas between the plurality of sense lines on the non-display area of the glass substrate.

2. The touch screen panel as claimed in claim 1, wherein the dummy patterns are made of the same material as the sense lines.

3. The touch screen panel as claimed in claim 1, wherein each of the dummy patterns is of an island shape, and is not electrically coupled to the sense lines.

4. The touch screen panel as claimed in claim 1, wherein the sense patterns include an X sense pattern and a Y sense pattern arranged on different layers.

5. The touch screen panel as claimed in claim 4, wherein
the X pattern includes a plurality of first units,
each of the first units includes a plurality of first sense patterns arranged in a first direction,
the Y pattern includes a plurality of second units,
each of the second units includes a plurality of second sense patterns arranged in a second direction different from the first direction,
adjacent first sense patterns in each of the first units are electrically coupled to each other in the first direction, and
adjacent second sense patterns in each of the second units are electrically coupled to each other in the second direction.
